(19) United States
(12) Patent Application Publication
(10) Pub. No.: US 2001/0043640 A1
(43) Pub. Date: Nov. 22, 2001

(54) METHOD AND APPARATUS FOR HEATING MATERIALS

(75) Inventors: HIROSHI SHIMIZU, WEXFORD, PA (US); JOSEPH L. HAKE, NEW CASTLE, PA (US); RICHARD L. COOK, PITTSBURGH, PA (US)

Correspondence Address: ANSEL M SCHWARTZ, ATTORNEY AT LAW, ONE STERLING PLAZA, 201 NORTH CRAIG STREET SUITE 304, PITTSBURGH, PA, 15213

(73) Assignee: ANSEL M. SCHWARTZ

(21) Appl. No.: 08/806,848

(22) Filed: Feb. 26, 1997

(51) Int. Cl. H05B 7/144; F27D 3/00

(52) U.S. Cl. 373/108; 373/81

(57) ABSTRACT

The present invention pertains to a direct current electric arc furnace for melting or heating raw materials or molten material. The furnace comprises a refractory lined vessel for holding raw or molten metal material. The furnace also comprises a first top electrode and at least a second top electrode. Each of the top electrodes enters the vessel above the raw or molten material and has a position in the vessel. The furnace comprises at least one bottom electrode mounted in the bottom of the vessel and in electrical contact with the raw or molten material in the vessel. Additionally, the furnace comprises an electrical power supply mechanism with conductors to electrically connect to the top electrodes and the bottom electrode in order to input electrical energy into the material through the top and bottom electrodes in the form of arcs which deflect toward each other and define a hot area. The first and second top electrodes have the same electrical polarity while the bottom electrode has an opposite electrical polarity to the electrical polarity of the top electrodes. The present invention pertains to a method for heating raw material. The method comprises the steps of providing direct current to a first top electrode and a second top electrode having the same electrical polarity, and to a bottom electrode having opposite polarity to the top electrodes in a vessel. Next, there is the step of creating a first electric arc in the vessel from the first top electrode which contacts the material. Then, there is the step of creating a second electrical arc in the vessel from the second top electrode which contacts the material and is deflected toward the first electric arc to create a hot area.

### CROSS-REFERENCE

This application is related to contemporaneously filed U.S. patent application Ser. No.______titled “A Method and Apparatus for Operating a Furnace” by Hiroshi Shimizu, Joseph L. Hake, and Richard L. Cook, having attorney docket number NKK-2, incorporated by reference herein, and U.S. patent application Ser. No.______titled “A Direct Current Arc Furnace and a Method for Operating the Arc Furnace” by Hiroshi Shimizu, Joseph L. Hake, and Richard L. Cook, having attorney docket number NKK-3, incorporated by reference herein.

### FIELD OF THE INVENTION

The present invention relates to a DC arc furnace generally used for melting scrap or raw materials by means of one or more electrical arcs. More specifically, the present invention relates to a DC arc furnace having at least two electrodes each with an arc deflecting toward the other electrode.

### BACKGROUND OF THE INVENTION

Previous furnaces, whether AC with three electrodes or DC with one top electrode, when direct feeding iron substitutes into the furnace, suffered the problem that it was not physically possible to feed the iron substitutes into the molten bath at the area of maximum power input to obtain maximum energy input into the feed material and minimize the possibility of icebergs (floating unmelted material).

The present invention, because it utilizes two top electrodes of the same polarity that are supplied DC energy, produce arcs which melts and/or heats molten material. These arcs tend to deflect towards each other resulting in the area directly between the electrodes at the bath level being the area of maximum power input and the preferable location of the iron substitute feed.

### SUMMARY OF THE INVENTION

The present invention pertains to a direct current electric arc furnace for melting or heating raw materials or molten material. The furnace comprises a refractory lined vessel for holding raw or molten metal material. The furnace also comprises a first top electrode and at least a second top electrode. Each of the top electrodes enters the vessel above the raw or molten material and has a position in the vessel. The furnace comprises at least one bottom electrode mounted in the bottom of the vessel and in electrical contact with the raw or molten material in the vessel. Additionally, the furnace comprises an electrical power supply mechanism with conductors to electrically connect to the top electrodes and the bottom electrode in order to input electrical energy into the material through the top and bottom electrodes in the form of arcs which deflect toward each other and define a hot area. The first and second top electrodes have the same electrical polarity while the bottom electrode has an opposite electrical polarity to the electrical polarity of the top electrodes.

The present invention pertains to a method for heating raw material. The method comprises the steps of providing direct current to a first top electrode and a second top electrode having the same electrical polarity, and to a bottom electrode having opposite polarity to the top electrodes in a vessel. Next, there is the step of creating a first electric arc in the vessel from the first top electrode which contacts the material. Then, there is the step of creating a second electrical arc in the vessel from the second top electrode which contacts the material and is deflected toward the first electric arc to create a hot area.

### BRIEF DESCRIPTION OF THE DRAWINGS

In the accompanying drawings, the preferred embodiment of the invention and preferred methods of practicing the invention are illustrated in which:

FIG. 1 is a schematic representation of a side view of a furnace of the present invention.

FIG. 2 is a schematic representation of an overhead view of the furnace.

FIG. 3 is a schematic representation of a side view of a portion of the furnace.

FIG. 4 is a schematic representation of an arm.

FIG. 5 is a schematic representation of an overhead view of a portion of the furnace with only one electrode.

FIG. 6 is a schematic representation of a perspective view of the furnace.

FIGS. 7a-7d are schematic representations of various views of the furnace cover.

FIGS. 8, 9 and 10 are schematic representations of various views of the arm and electrodes of the furnace.

FIG. 11 is a schematic representation of an overhead view of a portion of the furnace.

### DESCRIPTION OF THE PREFERRED EMBODIMENT

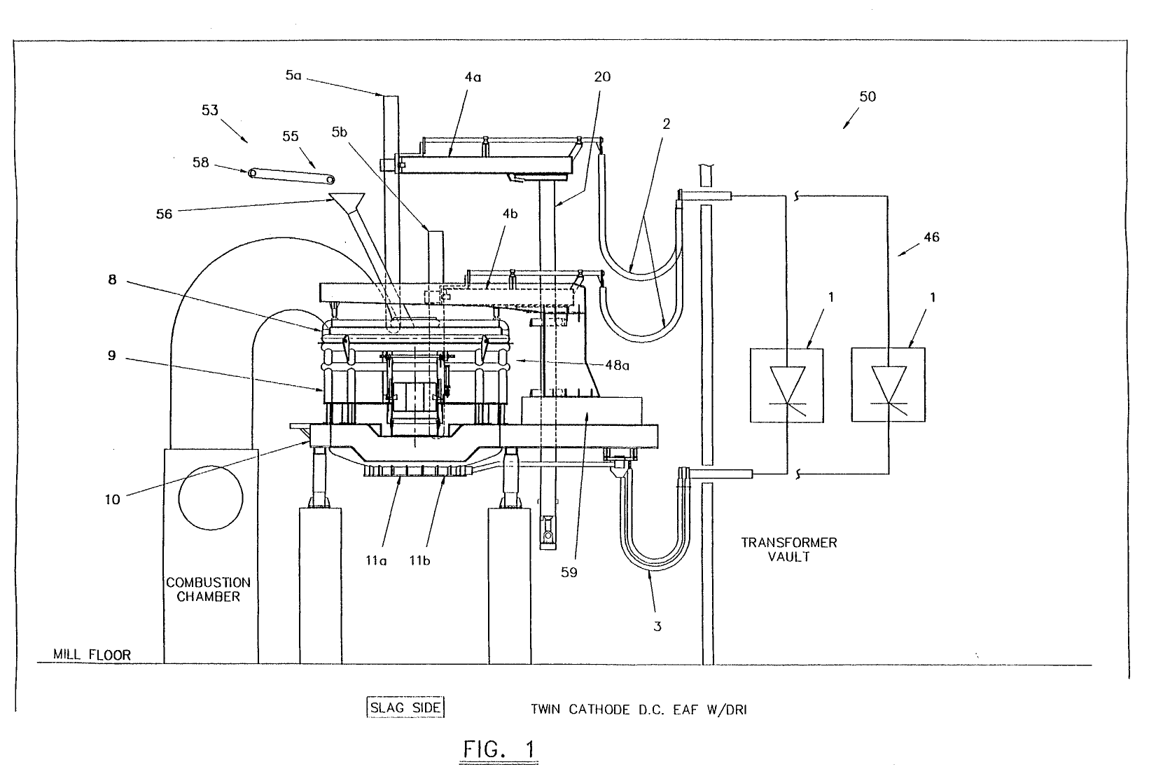

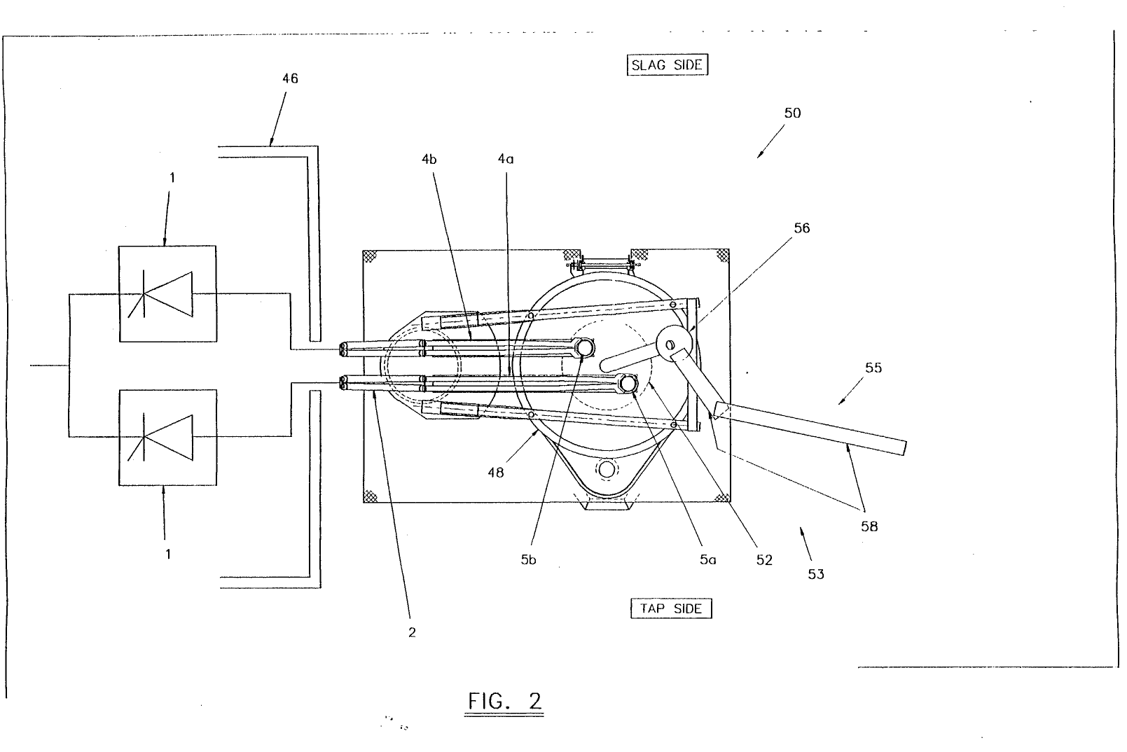

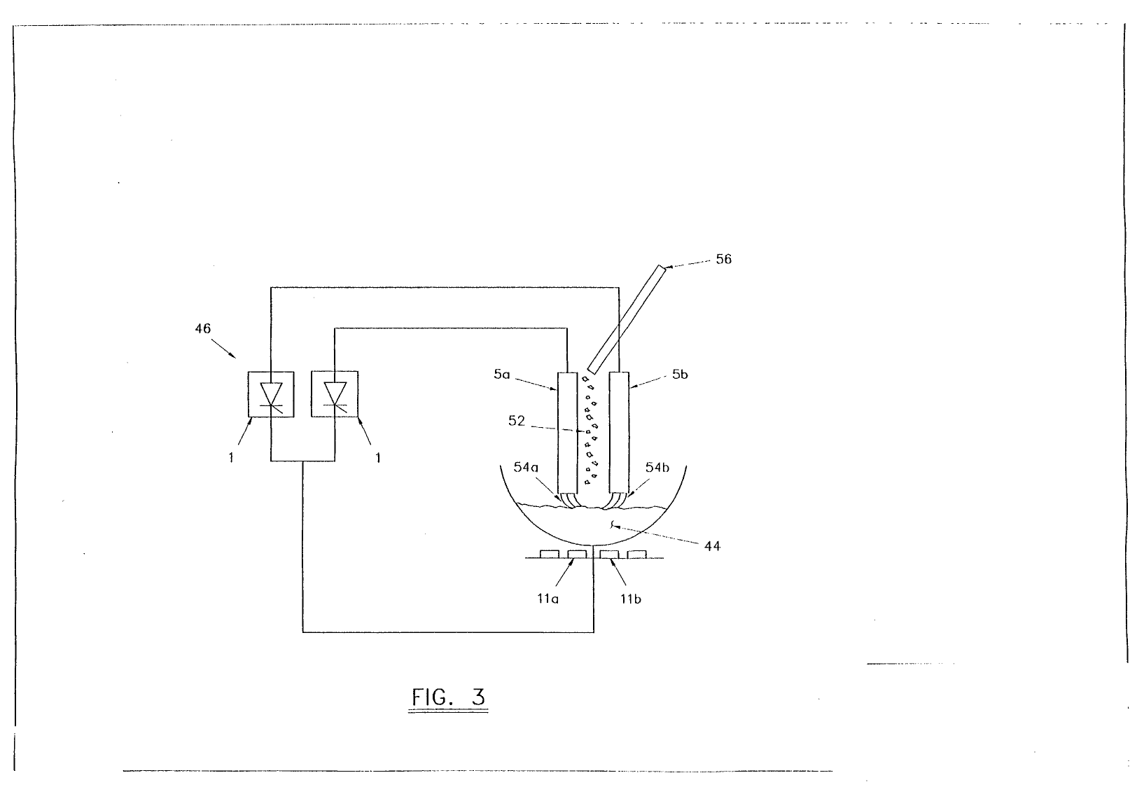

Referring now to the drawings wherein like reference numerals refer to similar or identical parts throughout the several views, and more specifically to FIGS. 1, 2 and 3 thereof, there is shown a direct current electric arc furnace 50 for melting or heating raw material 44 or molten material 44. The furnace 50 comprises a refractory lined vessel 48 for holding raw or molten metal material 44. The furnace 50 also comprises a first top electrode 5a and at least a second top electrode 5b. Each of the top electrodes enters the vessel 48 above the raw or molten material 44 and has a position in the vessel 48. The furnace 50 comprises at least a first bottom electrode 11a mounted in the bottom of the vessel 48 and in electrical contact with the raw or molten material in the vessel 48. Additionally, the furnace 50 comprises an electrical power supply mechanism 46 which electrically connects to the top electrodes and the first bottom electrode 11a in order to input electrical energy into the material through the top and bottom electrodes in the form of a first arc 54a and a second arc 54b which deflect toward each other and define a hot area 52. The first and second top electrodes have the same electrical polarity while the first bottom electrode 11a has an opposite electrical polarity to the electrical polarity of the top electrodes.

Preferably, the furnace 50 includes a mechanism 53 for introducing material to the hot area 52 in the vessel 48 to be heated. The introducing mechanism 53 is in contact with the vessel 48. The introducing mechanism 53 preferably includes a chute mechanism 55 which extends through the furnace cover 8. Preferably, the chute mechanism 55 includes a chute 56 which extends into the vessel 48 and guides material 44 sliding down it to the hot area 52. Additionally, the chute mechanism 55 preferably includes a conveyor mechanism 58 connected to the chute 56 which brings material 44 to the chute 56.

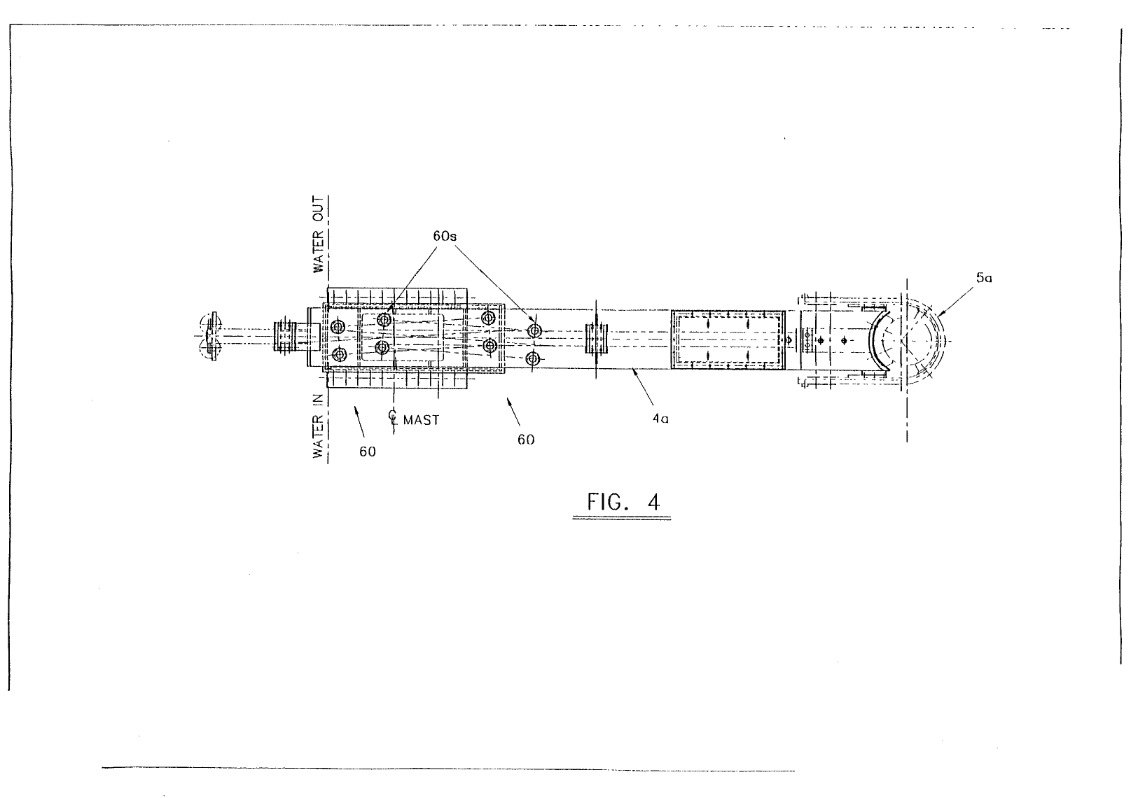

Preferably, the position of the first top electrode 5a in the vessel 48 is adjustable and the position of the second top electrode 5b in the vessel 48 is adjustable. Preferably, the first top electrode 5a is connected to a first arm 4a with bolts, as shown in FIG. 4. The first arm 4a has a variety of bolt holes 60 which allows the position of the first top electrode 5a to be varied in the vessel 48 depending on which bolt holes 60 the first top electrode 5a, through the first arm 4a, is bolted to. Similarly, the second top electrode 5b is connected to a second arm 4b with bolts and its position can be varied in the same way as the first top electrode's position is varied.

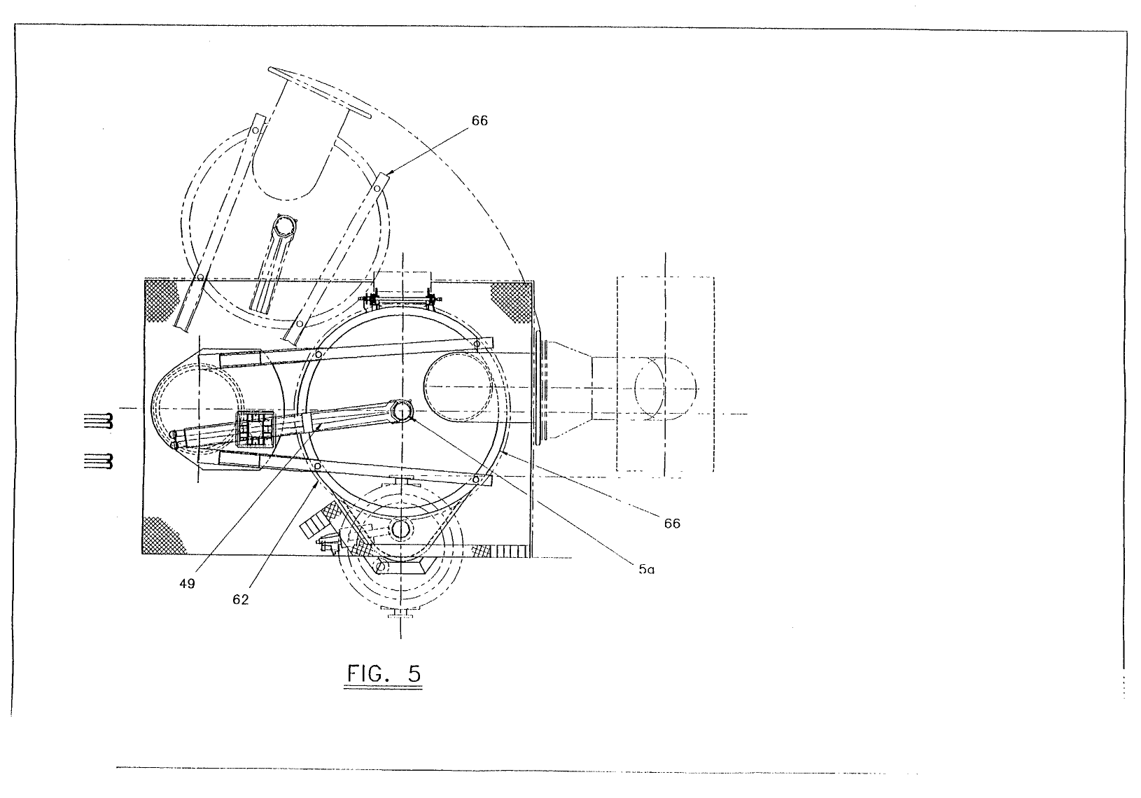

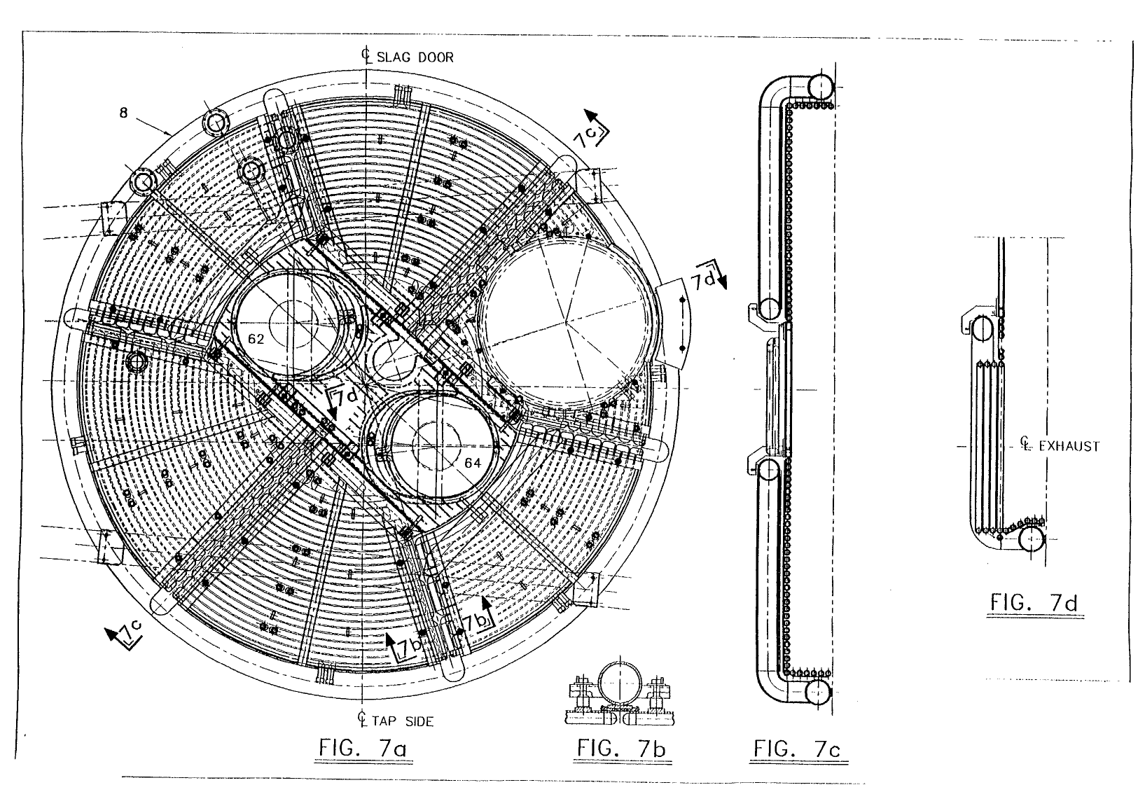

The vessel 48 preferably has a furnace cover 8 with a first port 62 and at least a second port 64, as shown in FIG. 7. The first and second electrodes extend through the furnace cover 8 into the vessel 48 through the first and second ports, respectively. Preferably, the furnace cover 8 has at least four port positions for the first and second ports. If desired, the vessel 48 is convertible to have only one top electrode 5b in it, as shown in FIG. 5. Bolt holes 60s, shown in FIG. 4, are then used to position the first top electrode 5a. In FIG. 5, the dotted lines represent the position of the refractory sleeve 66 when it is moved away from the first port 62 (this is the case for the dotted lines in all the figures).

There can be at least a second bottom electrode 11b mounted in the bottom of the vessel 48 and in electrical contact with the raw or molten material 44 and the vessel 48. The second bottom electrode 11b has the same electrical polarity as the first bottom electrode 11a and has opposite electrical polarity to the electrical polarity of the top electrodes.

The present invention pertains to a method for heating raw material. The method comprises the steps of providing direct current to a first top electrode 5a and a second top electrode 5b having the same electrical polarity, and to a first bottom electrode 11a having opposite polarity to the top electrodes in a vessel 48. Next, there is the step of creating a first electric arc 54a in the vessel 48 from the first top electrode 5a which contacts the material. Then, there is the step of creating a second electrical arc in the vessel 48 from the second top electrode 5b which contacts the material and is deflected toward the first electric arc 54a to create a hot area 52.

In one embodiment, before the creating a first electric arc 54a step there is the step of pouring the material down a chute 56 which directs the material to the hot area 52. In another embodiment, after the creating a second electric arc 54b step there is the step of adjusting the position of the first top electrode 5a in the vessel 48.

In the operation of the preferred embodiment and referring to FIGS. 1-3, the DC arc furnace comprises a refractory lined furnace shell 9 to contain the material to be melted, a furnace cover 8 to contain the heat energy in the furnace shell, one or more top electrodes 5, typically of graphite, protruding through the furnace cover 8 and capable of moving vertically in order to establish and arc between the tip of the electrode and the material 44 to be melted, an electrode arm 4 for each top electrode to support the electrode, a movable mast 20 to raise and lower the electrode, one or more bottom electrodes 11 located in the bottom of the furnace shell 9, one or more DC power supplies 1 to provide the necessary electrical energy to the furnace for melting, the necessary anode and cathode water cooled cables 2 and 3 to conduct the electrical energy from the power supplies to the furnace, typically the anode connections 3 go to the bottom electrode 11 and the cathode connections 2 to the top electrode 5. There is a tilt platform 10 which supports the furnace vessel 48, the superstructure 59, the electrode arms 4a and 4b and the electrodes 5a and 5b and provides for the capability to tilt the furnaces for tapping purposes and slagging off purposes.

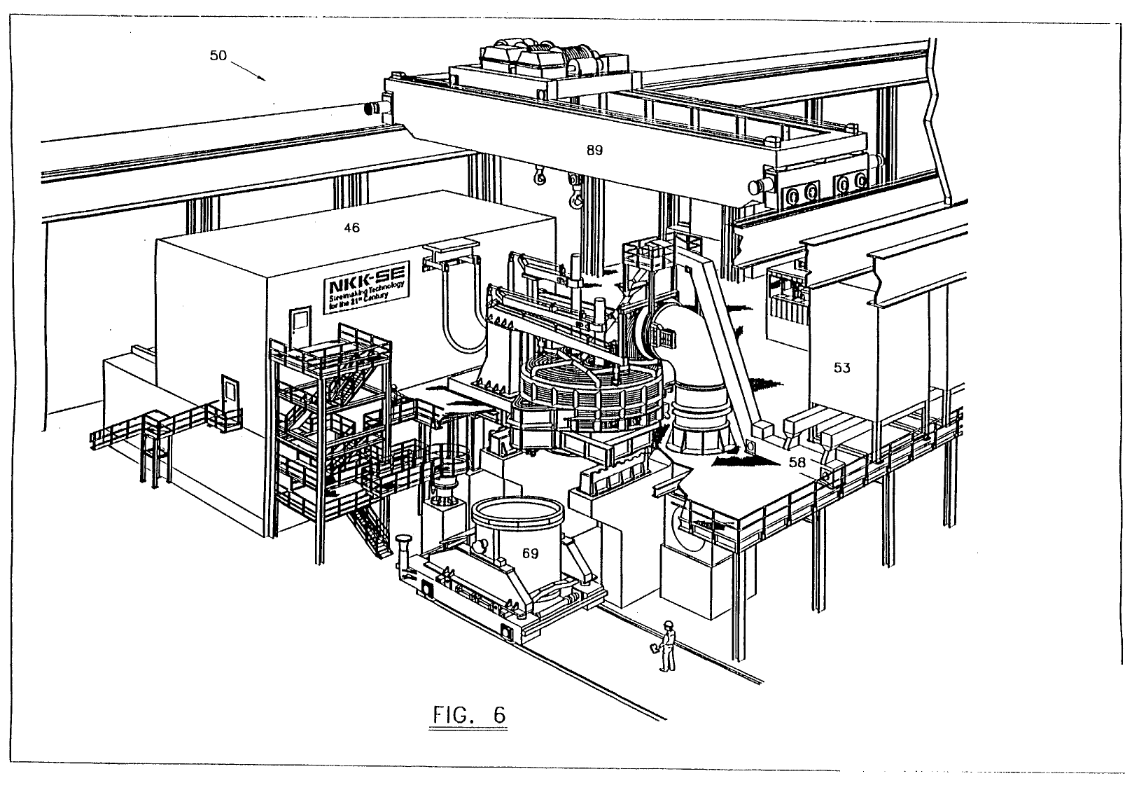

A typical operation sequence consists of removing the furnace cover 8 from the furnace shell 9 of the vessel 48, placing the charge material 44 (typically scrap iron and/or steel) in the furnace shell 9, putting the furnace cover 8 back on the furnace shell 9, energizing the DC furnace power supply 1 (which include, for instance, rectifiers of the power supply mechanism 46), and lowering the top electrode 5 to establish an arc 54 between the charge material which is electrically in contact with the bottom electrode 11 and the tip of the top electrode 5. This arcing continues until the charge material is melted. At this time, if additional molten material 44 is required, the above sequence will be repeated one or more times, or it might be desirable to continuously feed unmelted iron substitutes such as pre-reduced iron pellets into the molten charge material at a rate which corresponds to the capability of the furnace to melt it. This will continue until such time that the required total amount of molten material in the furnace is reached. At that point in time, the furnace is tapped (the molten material is poured into another vessel 69, see FIG. 6) for further processing.

A DC arc furnace comprises a refractory lined vessel to contain the material 44 to be melted and/or heated. There is a furnace cover 8 to contain the energy in the vessel during the process. There are one or more top electrodes protruding through the furnace cover 8 and movable vertically to obtain the desired distance between the bottom tip of the electrode(s) and the material 44 to be melted (heated). There are one or more removable or fixed bottom electrode(s) 11 located in the refractory lining of the bottom of the furnace shell 9. There are one or more DC power supplies electrically connected to the top and bottom electrodes such that an arc(s) 54 can be established between the top electrode(s) and the material to be melted (heated).

In regard to introducing the material, such as iron substitute or DRI, into the vessel 48, the DRI feed point is fixed so that the trajectory of the DRI will lead to the material hitting the molten metal bath level at a point centered between the two electrodes (i.e. the center of the vessel 48 at the metal line). In a vessel 48 where both scrap and DRI are melted, the scrap will generally be nearly completely melted prior to DRI feeding. Therefore the electrodes will be near or at their lowest position and the hottest point for DRI melting will be centered between the two electrodes at the metal level. The entry point of the DRI feed chute in the furnace cover 8 is also between the two electrodes. Since this area is the hottest point in the vessel 48 and the DRI is falling between the two electrodes where the power of the furnace is concentrated the likelihood of the DRI solidifying and forming “icebergs” is minimal.

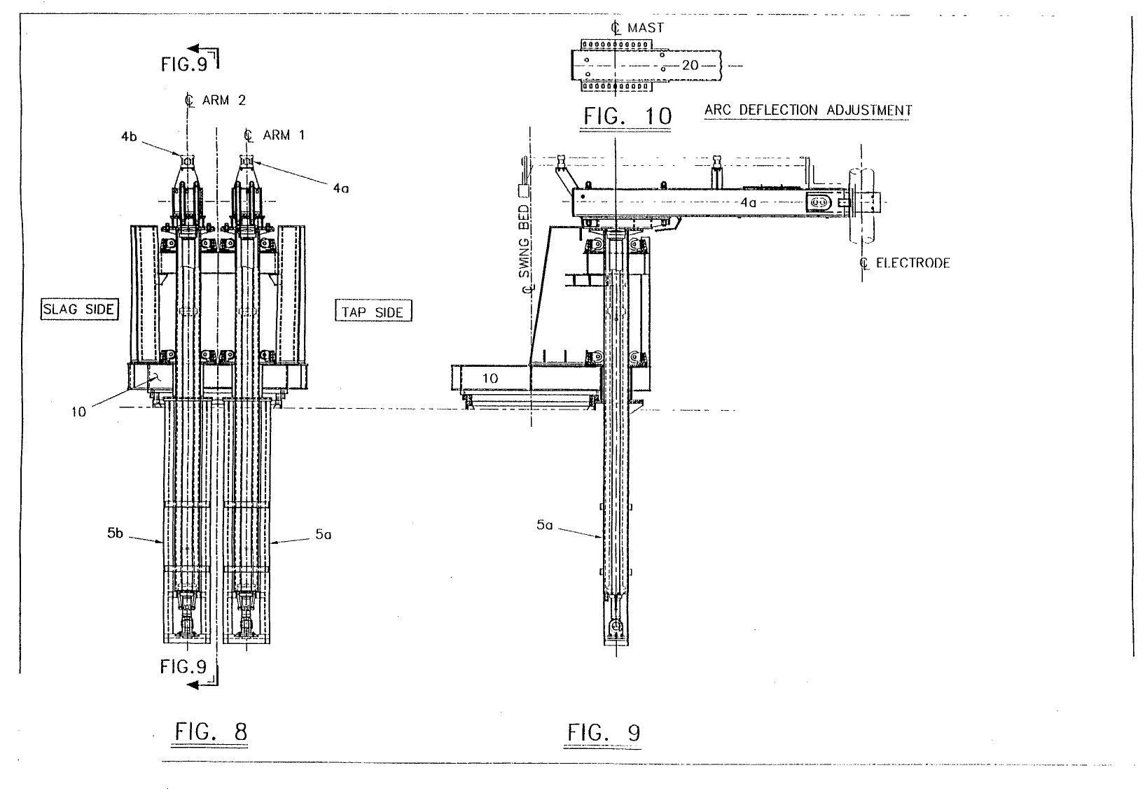

The position of the two electrodes can be adjusted forward or back to either increase or decrease the spacing between the two electrodes. The spacing between the electrodes is referred to as the pitch diameter or pitch circle. Preferably, the pitch circle is 92.50 inches. To attain the desired hot area 52, the top electrodes should be no further than half the diameter of the furnace apart to obtain deflection of the arcs toward each other. The inside diameter of the furnace shell is 277.5 inches. The closest an electrode 5 is to the furnace shell 9 is 92.5 inches. Each electrode arm is bolted to the top of the mast by 14 bolts (7 on a side) as shown in FIGS. 8, 9 and 10. The shorter or second arm 4b has two extra bolt holes per side on the back edge of the mounting plate and one extra hole per side on the front edge. The long or first arm 4a has the two extra holes on the front edge of the mounting plate and on extra hole on the back edge. By moving the short arm back and the long arm forward the pitch circle can be increased. The pitch circle can be decreased by moving the long arm back and the short arm forward. Other combinations of positions are also attainable where the center of the pitch circle would be shifted from the center of the furnace. This adjustability allows the furnace to be fine tuned for actual operating conditions. If the DRI is not melting sufficiently the pitch circle can be decreased to concentrate the power more towards the center of the furnace. If some of the water cooled sidewall panels are showing elevated temperatures the position of one or both of the arms can be adjusted to decrease the heat load on the affected panels.

The ports in the top for the electrode are adjustable to the 4 positions possible for each top electrode, as shown in FIG. 7. The electrode ports are located in a round refractory sleeve 66. The refractory sleeve 66 is mounted in an oval shape water cooled panel as is well known in the art. Both the electrode port and the opening in the water cooled panel for the refractory sleeve are eccentric. By rotating the refractory sleeve 180 degrees, two of the electrode port positions can be attained. By rotating the water cooled panel 180 degrees the other two electrode port positions can be achieved. Rotation of the refractory sleeve 66 is well known to one skilled in the art.

The long or first electrode arm 4a can be moved back on the mast 20 and set on an angle to convert the furnace to single cathode operation with minimal modifications to the electrode arm bus tubes and the water cooled roof. This modification is accomplished by unbolting the four large studs which attach the arm to the mounting bracket and re-bolting the arm through the four additional forward holes 605 on the arm as shown in FIG. 4. The top is also substituted with a top having only one port.

Because the top electrodes used for this type of furnace typically are made of graphite and the current carrying capacity of these electrodes is limited depending on the diameter of the electrode, and the power input to the furnace is a function of the arc current and arc voltage, one of the limiting factors as the maximum allowable power input is electrode size and its current carrying capability. Most of the large DC arc furnaces are equipped with one top electrode using a 28″ diameter electrode, which according to the electrode manufacturers should not be operated above 120,000 amperes, thereby limiting the power input to approximately 78 MW at 650 volts. Recent production by the electrode manufacturers of 29″ and 30″ diameter electrodes capable of up to 140 to 154 KA has increased the limit of power input to approximately 100 MW at 650 volts. The furnace 50 with at least two (but there could be 3, 4, 5, 6, 7 or 8 top electrodes, with corresponding changes in the number of ports, bottom electrodes 11, etc. could also be used) can attain in excess of 154 KA power input and preferably in excess of 160 KA power input. For instance, two electrodes at 120 KA each would yield 240 KA of energy being input into the material.

The electrode manufacturers produce the larger diameter electrodes at a premium. With multiple electrodes, it is possible to use smaller diameter electrodes and still maintain the same amount or more power into the furnace.

In a single electrode DC furnace, there is not a good place to introduce the iron substitute except to try to get it under the single electrode. In an AC furnace, it is possible to place the iron substitute in the middle of the three electrodes but the AC arc has a tendency to flare away from each other unlike the DC arc which has a tendency to attract each other creating an area 52 of high heat.

An arc furnace has certain areas which typically run hotter than other areas of the furnace. The side walls of the furnace closest to the electrode typically are hot areas of the furnace. The closer the electrodes are placed next to each other the further the electrodes are from the wall but the closer the electrodes are to each other. This results in greater electrode wear due to radiation from the other electrodes.

By having two or more top electrodes in the furnace, it allows the furnace to exceed the 100 MW limit and also allows the flexibility of attaining this power input at lower voltages by increasing the current to values larger than 154 KA. By adding more electrodes, there is basically no upper limit electrically to the power that can be put into the furnace. Furthermore, the furnace operator no longer has to pay a premium for large diameter electrodes.

By having more than one electrode, there exists a location for the feeding of iron substitutes which by design allows for the melting of the iron substitutes in an area 52 of concentrated power which prevents the forming of icebergs.

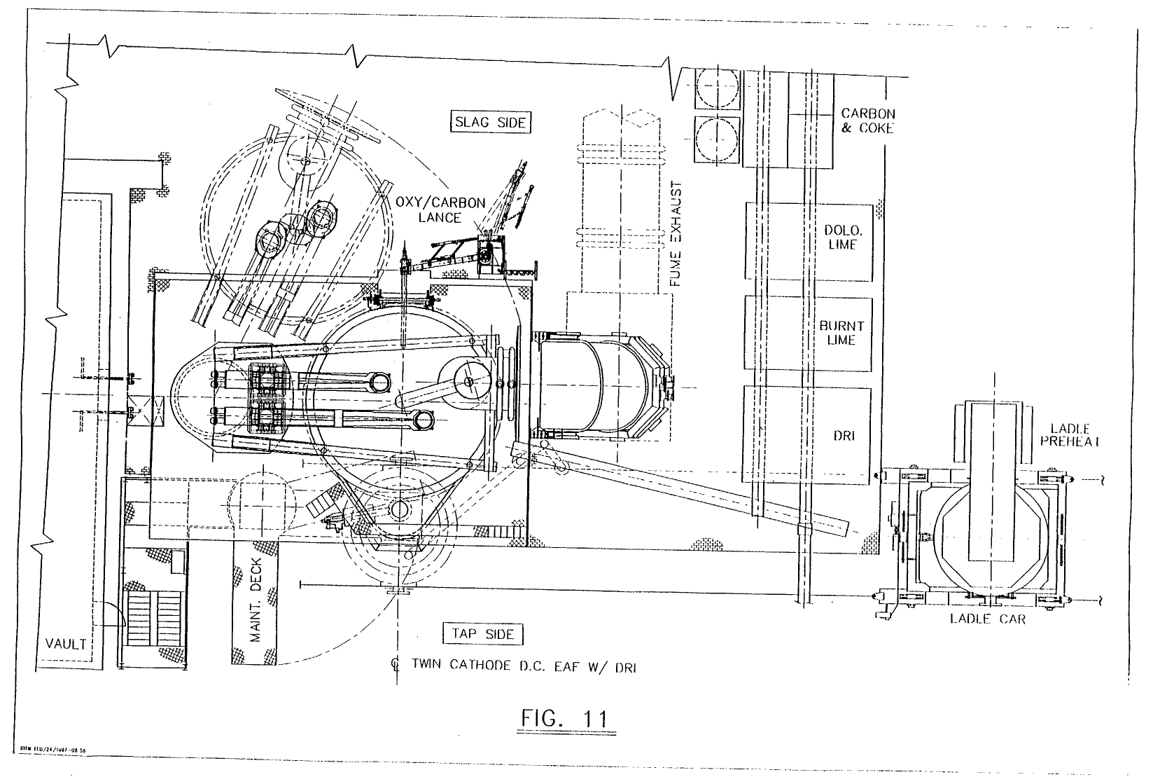

The length of the electrode arms can be adjustable which would allow the spacing between the electrode to be changed. By changing the distance between the electrodes, the hot areas within the furnace would also be affected which would allow for tuning and moving the area to more beneficial or colder locations. The wear patterns can be optimized between the furnace wall, roof and electrode by observing the interior of the furnace over time. The angle and length of the longer electrode also allows the furnace to be converted to a single electrode operation if required by substituting a single port furnace top onto the furnace. FIG. 11 shows an overhead view of a portion of the furnace 50.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A direct current electric arc furnace for melting or heating raw material or molten material comprising:
a refractory lined vessel for holding raw or molten material;
a first top electrode and at least a second top electrode, each of said top electrodes entering the vessel above the raw or molten material and having a position in the vessel;
at least a first bottom electrode mounted in the bottom of the vessel and in electrical contact with the raw or molten material in the vessel; and
an electrical power supply mechanism which electrically connects to the top electrodes and the bottom electrode in order to input electrical energy into the material through the top and bottom electrodes in the form of arcs which deflect toward each other and define a hot area; said first and second top electrodes having the same electrical polarity, and the bottom electrode having opposite electrical polarity to the electrical polarity of the top electrodes.

2. A furnace as described in claim 1 including a mechanism for introducing material to the hot area in the vessel to be heated, said introducing mechanism in contact with the vessel.

3. A furnace as described in claim 2 wherein the position of the first electrode in the vessel is adjustable.

4. A furnace as described in claim 3 wherein the vessel has a furnace cover with a first port and at least a second port, said first and second top electrodes extend through the furnace cover into the vessel through the first and second ports, respectively.

5. A furnace as described in claim 4 wherein the vessel is convertible to have only the first top electrode in it.

6. A furnace as described in claim 5 wherein the introducing mechanism includes a chute mechanism which extends through the furnace cover.

7. A furnace as described in claim 6 wherein the furnace cover has at least 4 port positions for the first and second ports.

8. A furnace as described in claim 7 wherein the first top electrode is connected to a first arm with bolts, said first arm has a variety of bolt holes which allows the position of the first top electrode to be varied in the vessel depending on which bolt holes the first electrode is bolted to.

9. A furnace as described in claim 8 wherein the chute mechanism includes a chute which extends into the vessel and guides material sliding down it to the hot area; and a conveyor mechanism connected to the chute which brings material to the chute.

10. A furnace as described in claim 9 including at least a second bottom electrode mounted in the bottom of the vessel and in electrical contact with the raw or molten material in the vessel, said second bottom electrode having the same electrical polarity as the first bottom electrode and having opposite electrical polarity to the electrical polarity of the top electrodes.

11. A furnace as described in claim 10 wherein the position of the second top electrode in the vessel is adjustable.

12. A method for heating raw material comprising the steps of:
providing direct current to a first top electrode and a second top electrode having the same electrical polarity, and to a bottom electrode having opposite polarity to the top electrodes in a vessel;
creating a first electric arc in the vessel from the first top electrode which contacts the material; and
creating a second electric arc in the vessel from the second top electrode which contacts the material and is deflected toward the first electric arc to create a hot area.

13. A method as described in claim 12 wherein before the creating a first electric arc step, there is the step of pouring the material down a chute which directs the material to the hot area.

14. A method as described in claim 12 wherein after the creating a second electric arc step there is the step of adjusting the position of the first electrode in the vessel.

15. A direct current electric arc furnace for melting or heating raw material or molten material comprising:
a refractory lined vessel for holding raw or molten material;
a first top electrode and at least a second top electrode, each of said top electrodes entering the vessel above the raw or molten material and having a position in the vessel;
at least a first bottom electrode mounted in the bottom of the vessel and in electrical contact with the raw or molten material in the vessel; and
an electrical power supply mechanism which electrically connects to the top electrodes and the bottom electrode in order to input more than 160 KA of electrical energy into the material through the top and bottom electrodes in the form of arcs; said first and second top electrodes having the same electrical polarity, and the bottom electrode having opposite electrical polarity to the electrical polarity of the top electrodes.

16. A furnace as described in claim 15 wherein the electrical supply mechanism provides at least 240 KA of electrical energy into the material through the tip and bottom electrodes in the form of arcs.
